(19) United States
(12) Patent Application Publication
(10) Pub. No.: US 2023/0135592 A1
(43) Pub. Date: May 4, 2023

(54) ELECTRODE PLATE FOR SECONDARY BATTERY, METHOD FOR PRODUCING SAME, SECONDARY BATTERY, AND METHOD FOR PRODUCING SAME

(71) Applicant: SANYO Electric Co., Ltd., Kadoma-shi, Osaka (JP)

(72) Inventors: Hidemasa Kawai, Hyogo (JP); Naoki Uchida, Hyogo (JP); Haruya Nakai, Hyogo (JP)

(73) Assignee: SANYO Electric Co., Ltd., Kadoma-shi, Osaka (JP)

(21) Appl. No.: 17/912,708

(22) PCT Filed: Feb. 8, 2021
(86) PCT No.: PCT/JP2021/004636

§ 371 Date: Sep. 19, 2022

(30) Foreign Application Priority Data
Mar. 27, 2020 (JP) 2020-057156

(51) Int. Cl. H01M 4/36; H01M 4/134; H01M 50/406

(52) U.S. Cl. CPC H01M 4/366; H01M 4/134; H01M 50/406

(57) ABSTRACT

This electrode plate for a secondary battery comprises a thin plate-shaped core formed from a metal foil and an active material layer formed on at least one surface of the core. A melted section of the metal foil forming the core is scattered at an end section of the electrode plate for a secondary battery so as to spread from the plate thickness range of the core to the end face of the active material layer, adheres thereto, and is solidified.

### TECHNICAL FIELD

The present disclosure relates to a secondary battery electrode plate and a method for manufacturing the same, and a secondary battery and a method for manufacturing the same.

### BACKGROUND

A negative or positive electrode plate used for a secondary battery may be manufactured by cutting, to a predetermined size of the electrode, an electrode precursor in which a long piece of active material layer is formed on a long piece of thin-plate-shaped core.

Patent Literature 1 discloses preventing a core of a secondary battery electrode plate from protruding more outward than an active material layer at a cut edge when the secondary battery electrode plate is cut with laser. An electrode precursor with an active material layer formed on each side of a long piece of core is cut with laser such that the edge of the core at the edge of the electrode plate is widened into a triangular cross section. The edge of the core is positioned more inward than the edge of the active material layer with respect to the surface plane of the electrode plate, or positioned flush with the edge of the active material layer.

### Citation List

### Patent Literature

PATENT LITERATURE 1: International Publication No. WO 2018/043444 A

### SUMMARY

When a secondary battery electrode plate is cut from a long piece of electrode precursor, an active material may peel off at a cut edge of the active material layer and fall down.

A secondary battery electrode plate according to an embodiment of the present disclosure comprises a core made from a metal foil and having a thin-plate shape, and an active material layer formed on at least one side of the core. A melted portion of the metal foil forming the core disperses at an edge portion of the secondary battery electrode plate such that the melted portion spreads beyond a plate thickness region of the core to adhere to and solidify on an edge of the active material layer.

A secondary battery according an embodiment of the present disclosure comprises the secondary battery electrode plate according to an embodiment of the present disclosure.

In a secondary battery electrode plate manufacturing method according to an embodiment of the present disclosure, when manufacturing the secondary battery electrode plate or a semi-finished electrode plate to be used as the secondary battery electrode plate by cutting, with laser, an electrode precursor comprising a thin-plate shaped based core made from a metal foil and an active material base layer formed on at least one side of the base core, a melted portion produced by melting the metal foil disperses at an edge portion of the secondary battery electrode plate such that the melted portion spreads beyond a plate thickness region of the core to an edge of the active material layer.

The secondary battery electrode plate manufacturing method according to an embodiment of the present disclosure uses the secondary battery electrode plate manufactured by the secondary battery electrode plate manufacturing method according to an embodiment of the present disclosure.

A secondary battery electrode plate and a method for manufacturing the same, and a secondary battery and a method for manufacturing the same according to an embodiment of the present disclosure can prevent the active material layer from peeling off at a cut edge without widening an edge portion of the core into a triangular cross section.

### BRIEF DESCRIPTION OF DRAWINGS

FIG. 1 is a cross sectional diagram of a secondary battery according to an embodiment of the present disclosure.

FIG. 2 is perspective diagram showing an electrode assembly of the secondary battery shown in FIG. 1 with an unwound winding-end edge.

FIG. 3 is an unwound diagram showing a longitudinal portion of a negative electrode precursor used to form a negative electrode plate of the electrode assembly shown in FIG. 2.

FIG. 4 is a cross sectional diagram cut along line A-A in FIG. 3.

FIG. 5 is a cross sectional diagram showing a cut edge portion of the negative electrode plate.

FIG. 6 is a schematic diagram showing an SEM image of a cut edge of the negative electrode plate according to an embodiment of the present disclosure.

### DESCRIPTION OF EMBODIMENTS

As a result of thoughtful consideration to address the above problem, the inventors found that, in a structure of a secondary battery electrode plate including a thin-plate-shaped core made from a metal foil and an active material layer formed on at least one side of the core, an active material layer can be prevented from falling down at a cut edge without widening the edge portion of the core into a triangle cross section by using a configuration in which a melted portion of the metal foil forming the core disperses at an edge portion of the secondary battery electrode plate such that the melted portion scatters beyond a plate thickness region of the core to adhere to the edge of the active material layer. This is described in detail below.

An embodiment of the present disclosure is described below. In the description below, specific shapes, materials, directions, values, and the like are merely examples used to facilitate understanding of the present disclosure. These specifics may be changed to adapt to usages, purposes, specifications, and so on. In the embodiments described below, the secondary battery is assumed to be a non-aqueous electrolyte secondary battery in which a wound-type electrode assembly is enclosed in a housing which is a rectangular metal case.

### Secondary Battery Configuration

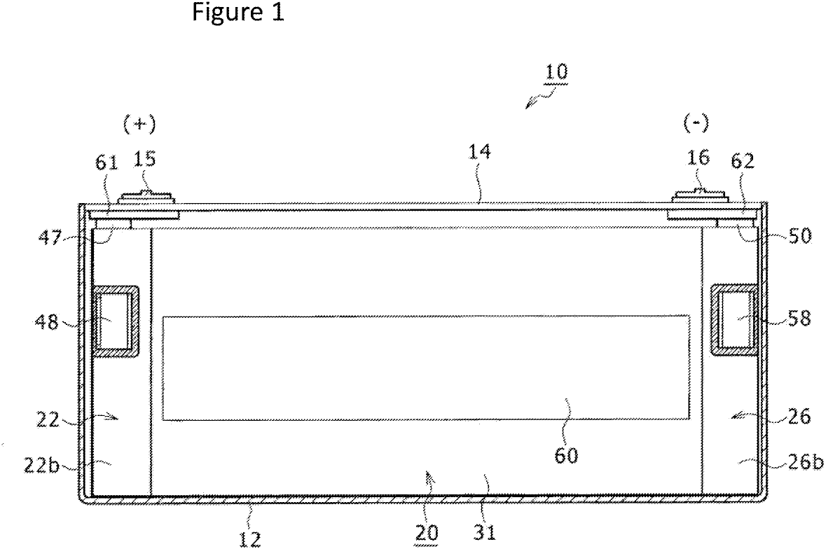

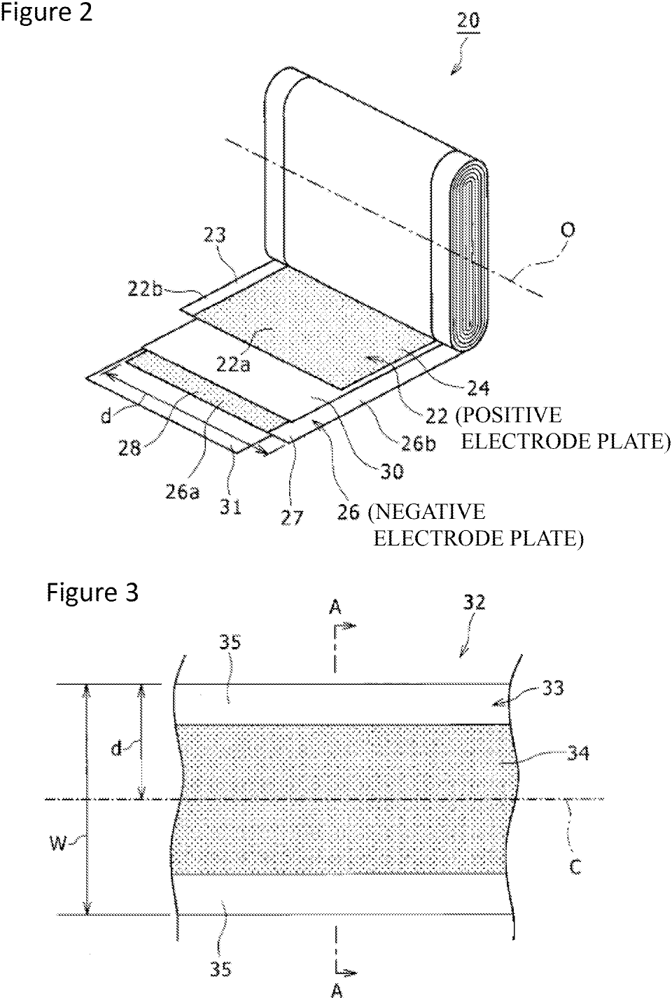

Initially, a configuration of a secondary battery 10 is described with reference to FIGS. 1 and 2. FIG. 1 is a cross sectional diagram of the secondary battery 10. FIG. 2 is a perspective diagram showing an unwound winding-end edge of an electrode assembly 20 of the secondary battery 10.

The secondary battery 10 includes a housing 12 used as a case, and the wound-type electrode assembly 20 that is disposed in the housing 12. Non-aqueous electrolytic solution acting as non-aqueous electrolyte is stored in the housing 12. The non-aqueous electrolytic solution may be an electrolytic solution that contains, for example, lithium salt, and is lithium-ion conductive.

As shown in FIG. 2, the electrode assembly 20 has a wound structure with the winding axis O extending in a longitudinal direction of the secondary battery 10. A positive electrode plate 22 and a negative electrode plate 26 are wound via separators 30, 31 into a flat cuboid shape. In the electrode assembly 20, for example, a long piece of positive electrode plate 22, a long piece of separator 30, a long piece of negative electrode plate 26, and a long piece of separator 31 are stacked and wound such that the separator 31 is disposed at the outermost surface. The positive electrode plate 22 and the negative electrode plate 26 are used as secondary battery electrode plates.

As shown in FIG. 1, the metal housing 12 has a box shape with an opening at the top. The secondary battery 10 includes a sealing plate 14 which closes the opening. The housing 12 and the sealing plate 14 may be made from aluminum or an aluminum alloy. A positive electrode terminal 15 protrudes at one longitudinal end (around the left end in FIG. 1), whereas a negative electrode terminal 16 protrudes at the other longitudinal end (around the right end in FIG. 1) on the sealing plate 14. With the positive electrode terminal 15 and the negative electrode terminal 16 being inserted into two through holes made in the sealing plate 14, these terminals are fastened onto the sealing plate 14 via resin gaskets. The winding axis of the electrode assembly 20 is parallel to the longitudinal direction of the sealing plate 14 (the right-left direction in FIG. 1). An insulation sheet that is folded into a box shape may be provided inside the housing 12 such that the electrode assembly 20 and the housing 12 are insulated from each other.

### Positive Electrode Plate

The positive electrode plate 22 includes a positive electrode core 23, and a positive electrode active material layer 24 that may be formed on each side of the positive electrode core 23 and contains a positive electrode active material. FIG. 2 shows the positive electrode active material layer 24 in a hatch pattern of a sand texture. The positive electrode core 23 is a thin-plate-shaped core made from a foil of metal that is stable within a potential range of the positive electrode, such as, aluminum or an aluminum alloy. The positive electrode active material may be a lithium transition metal oxide that allows insertion and release of lithium ions. The positive electrode active material layer 24 may contain a binder and a conductive agent in addition to the positive electrode active material. The positive electrode plate 22 includes a main portion 22a in which the positive electrode active material layer 24 is formed on the positive electrode core 23, and a positive electrode core exposed portion 22b in which the positive electrode core 23 is exposed with no positive electrode active layer formed thereon. The positive electrode core exposed portion 22b is formed along one of the side edges of the positive electrode plate 22 before being wound. In the positive electrode plate 22, a porous protective layer thinner than the positive electrode active material layer 24 may be further formed in an area next to the positive electrode active material layer 24 in the positive electrode core exposed portion 22b.

A lithium transition metal oxide containing transition metal elements such as Co, Mn, and Ni may be used as the positive electrode active material. Examples of the lithium transition metal oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (M: at least one of the group consisting of Na, Mg, Sc, Y, Mn, Fe, Co, Ni, Cu, Zn, Al, Cr, Pb, Sb, and B, 0 < x ≤ 1.2, 0 < y ≤ 0.9, 2.0 ≤ z ≤ 2.3). These materials may be used alone or in combination. In order to increase the capacity of the secondary battery 10, the positive electrode active material may contain a lithium nickel composite oxide, such as LiₓNiO₂, LiₓCo_{y}Ni_{1-y}O₂, and LiₓNi_{1-y}M_{y}O_{z} (M: at least one of the group consisting of Na, Mg, Sc, Y, Mn, Fe, Co, Ni, Cu, Zn, Al, Cr, Pb. Sb, and B, 0 < x ≤ 1.2, 0 < y ≤ 0.9, 2.0 ≤ z ≤ 2.3).

The conductive agent used for the positive electrode active material layer 24 may be, for example, carbon particles, such as, carbon black (CB), acetylene black (AB), ketjen black, carbon nanotube (CNT), and graphite. These materials may be used alone or in combination of two or more. Carbon black may be desirably used as the conductive agent for the positive electrode active material layer 24.

The binder used for the positive electrode active material layer 24 may be a resin, for example, a fluorine resin, such as polytetrafluoroethylene (PTFE) and polyvinylidene fluoride (PVDF), polyacrylonitrile (PAN), a polyimide resin, an acrylic resin, and a polyolefin resin. These resins may be used alone or in combination of two or more. Polyvinylidene fluoride may be desirably used as the conductive agent for the positive electrode active material layer 24.

The positive electrode plate 22 may be manufactured by forming the positive electrode active material layer 24 on each side of the positive electrode core 23. Each positive electrode active material layer 24 may be formed by coating the positive electrode core 23 with a positive electrode active material layer slurry containing the positive electrode active material, the binder, and a dispersion medium, and compressing the coated film after drying the coated film to remove the dispersion medium. The positive electrode plate may also be manufactured by forming the positive electrode active material layer 24 and a protective layer on each side of the positive electrode core 23 by coating the positive electrode core 23 with the positive electrode active material layer slurry and a protective layer slurry, and compressing the coated film after drying the coated film to remove the dispersion medium.

### Negative Electrode Plate

The negative electrode plate 26 includes a negative electrode core 27, and a negative electrode active material layer 28 that may be formed on each side of the negative electrode core 27 and contains a negative electrode active material. FIG. 2 shows the negative electrode active material layer 28 in a hatch pattern of a sand texture. The negative electrode core 27 is a thin-plate-shaped core made from a foil of metal that is stable within a potential range of the negative electrode, such as copper or a copper alloy. The negative electrode active material may be a carbon material, a silicon compound, or other material which allows insertion and release of lithium ions. The negative electrode active material layer 28 may contain a binder in addition to the negative electrode active material. The negative electrode plate 26 includes a main portion 26a in which the negative electrode active material layer 28 is formed on the negative electrode core 27, and a negative electrode core exposed portion 26b in which the negative electrode core 27 is exposed with no negative electrode active layer formed thereon. The negative electrode core exposed portion 26b extends along one of the side edges of the negative electrode plate 26 before being wound.

The negative electrode active material is not limited to a particular material as long as, for example, lithium ions can be reversibly absorbed into and released from the material. The negative electrode active material may be, for example, natural graphite, a carbon material, such as artificial graphite, a metal which can form an alloy with lithium, such as silicon (Si) and tin (Sn), an alloy containing a metal element, such as Si or Sn, or an composite oxide. A carbon material may be desirably used as the negative electrode active material. Natural graphite is more desirable. The negative electrode active material may be used alone or in combination of two or more.

The negative electrode plate 26 may be manufactured by forming the negative electrode active material layer 28 on each side of the negative electrode core 27. Each negative electrode active material layer 28 may be formed by coating the negative electrode core 27 with a negative electrode active material layer slurry containing the negative electrode active material, the binder, and a dispersion medium, and compressing the coated film after drying the coated film to remove the dispersion medium.

Particularly in this embodiment, as shown in FIG. 5 described below, in the negative electrode plate 26, a melted portion of the metal foil forming the negative electrode core 27 disperses beyond a plate thickness region t of the negative electrode core 27 at an edge portion of the negative electrode plate 26 such that the melted portion spreads to adhere to and solidify on the edges of the negative electrode active material layers 28. FIG. 5 shows the solidified melted portion of the metal foil of the negative electrode core 27 in a hatch pattern of diagonal lines. As described below, this can prevent each negative electrode active material layer 28 from peeling off at a cut edge 28a of the negative electrode active material layer 28 without widening the edge portion of the negative electrode core 27 into a triangular cross section.

As shown in FIG. 1, in the electrode assembly 20, the wound positive electrode core exposed portion 22b is disposed at one end (the left end in FIG. 1) in the winding axis direction (the right-left direction in FIG. 1). The wound negative electrode core exposed portion 26b is positioned at the other end (the right end in FIG. 1) in the winding axis direction of the electrode assembly 20.

### Separator

When wound, the separator 30 is disposed between the positive electrode plate 22 and the negative electrode plate 26 to electrically separate the positive electrode plate 22 and the negative electrode plate 26. The outermost separator 31 prevents short circuits between the negative electrode plate 26, which is the outermost electrode, and external elements.

Ion-permeable and insulative porous sheets are used for the separators 30, 31. The porous sheets may be, for example, microporous thin films, woven fabrics, or non-woven fabrics. A suitable material for the separators 30, 31 includes an olefin resin, such as polyethylene and polypropylene, and cellulose. Each separator 30, 31 may be a laminate including thermoplastic resin fiber layers, such as cellulose fiber layers and olefin resin layers. Each separator 30, 31 may be a multi-layered separator including a polyethylene layer and a polypropylene layer. The separator 30, 31 may be coated with a material such as an aramid resin or ceramic. For example, each separator 30, 31 may be a three-layered separator constructed from polyethylene layers with a polypropylene layer sandwiched therebetween.

In the electrode assembly 20, a piece of insulation tape 60 (FIG. 1) is adhered on the front or back surface of the electrode assembly 20 to fix the winding-end edge of the outermost separator 31 on the outer circumference of the electrode assembly 20.

A positive electrode current collector 47 is electrically connected to the wound positive electrode core exposed portion 22b. This electrically connects the positive electrode current collector 47 to the positive electrode plate 22. The positive electrode current collector 47 and a positive electrode receiving element 48 disposed on one side (the front side of the sheet of paper on which FIG. 1 is drawn) of the electrode assembly 20 opposite from the positive electrode current collector 47 are unitedly and electrically connected to the positive electrode plate 22 with the positive electrode core exposed portion 22b sandwiched therebetween. The positive electrode current collector 47 is electrically connected to the bottom of the positive electrode terminal 15 which extends vertically through a first insulating member 61 disposed on the inner surface of the sealing plate 14.

A negative electrode current collector 50 is electrically connected to the wound negative electrode core exposed portion 26b. This electrically connects the negative electrode current collector 50 to the negative electrode plate 26. The negative electrode current collector 50 and a negative electrode receiving element 58 disposed on one side (the front side of the sheet of paper on which FIG. 1 is drawn) of the electrode assembly 20 opposite from the negative electrode current collector 50 are unitedly and electrically connected to the negative electrode plate 26 with the negative electrode core exposed portion 26b sandwiched therebetween. The negative electrode current collector 50 is electrically connected to the bottom of the negative electrode terminal 16 which extends vertically through a second insulating member 62 disposed on the inner surface of the sealing plate 14.

The opening of the housing 12 is closed with the sealing plate 14 welded along the opening edge.

### Manufacturing Method of Negative Electrode Plate and Secondary Battery

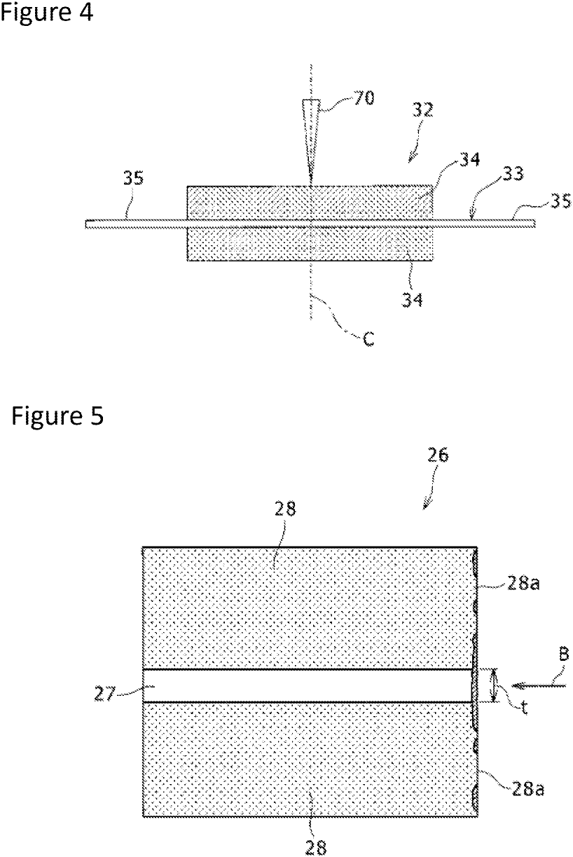

With reference to FIGS. 3 to 6, a manufacturing method of the secondary battery 10, in particular, the negative electrode plate 26 (FIGS. 2 and 5), is described below. FIG. 3 is an unwound diagram showing a longitudinal portion of a negative electrode precursor 32 used to form the negative electrode plate 26. FIG. 4 is a cross-sectional view cut along line A-A in FIG. 3. In a manufacturing method of the negative electrode plate 26 according to the present embodiment of the present disclosure, two or more negative electrode plates 26 are manufactured at the same time. First, a precursor manufacturing process is performed to manufacture the negative electrode precursor 32 (FIGS. 3 and 4) having a width W (FIG. 3) which equals to the total of widths d (FIGS. 2 and 3) of the two negative electrode plates 26. The negative electrode precursor 32 is a longitudinal plate including a longitudinal negative electrode base core 33, on each side of which a negative electrode active material base layer 34 is formed. The negative electrode precursor 32 corresponds to an electrode precursor. FIGS. , 3 and 4 show the negative electrode active material base layer 34 in a hatch pattern of a sand texture. The negative electrode active material base layer 34 may be formed by preparing a negative electrode active material layer slurry containing a negative electrode active material, a binder, and a dispersion medium, coating each surface of the negative electrode base core 33 with the slurry, and drying the coated film to remove the dispersion medium. A core exposed portion 35 extends along the longitudinal direction (the right-left direction in FIG. 3, and the front-rear direction of the sheet of paper on which FIG. 4 is drawn) at each lateral (the vertical direction in FIG. 3, and the right-left direction in FIG. 4) end of the negative electrode precursor 32. The core exposed portions 35 are where no active material layer is formed and the negative electrode base core 33 is exposed. The core exposed portions 35 may be formed by not applying the negative active material layer slurry. Alternatively, the core exposed portions 35 may be formed by first forming the negative active material layers on the entire areas on both sides, and then partially removing the negative electrode active material layers. The negative electrode base core 33 corresponds to a base core, and the negative electrode active material base layer 34 corresponds to an active material base layer.

Next in the manufacturing method of the negative electrode plate 26, the negative electrode precursor 32 is compressed using a compression roller or other means to compress the negative electrode active material base layer 34 in a compression process. In the manufacturing method of the negative electrode plate, the negative electrode precursor 32 is then cut along the lateral center (broken line C in FIGS. 3 and 4), and further cut to a predetermined longitudinal length in a cut process. In order to cut the negative electrode precursor 32 at the lateral center, a laser device can be used to emit a laser beam 70 (FIG. 4) to the lateral center of the negative electrode precursor 32 while changing a relative position between a processing head of the laser device and the negative electrode precursor 32 along the longitudinal direction (the front-rear direction of the sheet of paper on which FIG. 4 is drawn) of the negative electrode precursor 32. For example, the negative electrode precursor 32 may be fed by a conveyor in the front-rear direction of the sheet of paper on which FIG. 4 is drawn. The position of the processing head of the laser device may be fixed, or moved in the direction opposite to the movement of the negative electrode precursor 32.

The laser device includes, for example, a laser oscillator, and a processing head with a built-in galvano scanner. The laser oscillator emits laser light in a continuous wave mode in which the laser oscillator can continuously produce oscillations. For example, a fiber laser, a YAG laser, a Co₂ laser, or an Ar laser may be used as the laser oscillator. In the laser device, a collimator that convers laser light outputted from the laser oscillator to parallel light is disposed between the laser oscillator and the galvano scanner. The galvano scanner guides the laser light which has passed through the collimator to a reflective mirror, an optical element such as a diffractive optical element, an x-axis mirror, and a y-axis mirror in this order. The x axis extends along the longitudinal direction of the negative electrode precursor 32. The y-axis extends along the lateral direction of the negative electrode precursor 32. The laser light reflected by the x-axis mirror and the y-axis mirror passes through an Fθ lens and a protective glass, and then to the negative electrode precursor 32. The laser light scanning can be performed while moving the x-axis mirror and the y-axis mirror, and the radiation spots can be changed in plane.

For the laser radiation using the laser device, a continuous wave laser (CW laser) may be used to produce laser output (laser light output) of 1,200 W to 1,550 W at the scan speed (cut speed) of the laser beam of 3,000 mm/sec to 8,000 mm/sec with respect to the negative electrode precursor 32. More preferably, using the continuous wave laser for the laser radiation, with the scan speed of the laser beam of 5,000 mm/sec to 8,000 mm/sec with respect to the negative electrode precursor 32, the laser output may be from 1,200 W to 1,400 W, whereas with the scan speed of the laser beam of 3,000 mm/sec to less than 5,000 mm/sec with respect to the negative electrode precursor 32, the laser output may be from 1,300 W to 1,550 W. This allows a melted portion produced by melting the metal foil when cutting the negative electrode plate 26 from the negative electrode precursor 32 with laser to disperse at a cut edge portion of the negative electrode plate 26 such that the melted portion spreads on the cut edge 28a of the negative electrode active material layer 28 beyond the thickness region of the negative electrode core 27 in the manufacturing method of the negative electrode plate 26.

In the present embodiment, as described above, the width W (FIG. 3) of the negative electrode precursor 32 equals to the total (FIGS. 2 and 3) of widths d of the two negative electrode plates 26. Two longitudinal semi-finished negative electrodes cut to have a width d corresponding to the width of the negative electrode plate 26 can be obtained by cutting the negative electrode precursor 32 along the longitudinal direction by radiating the laser beam to the negative electrode precursor 32 along the lateral center as described above.

As the negative electrode precursor 32 is linearly cut at the lateral center with the laser beam, the laser device may be configured to radiate the laser beam in a single dimension. For example, in the laser device, the y-axis mirror may be omitted or immovably disposed.

In the cutting process, the two semi-finished negative electrodes obtained above may be cut at certain longitudinal positions to obtain multiple negative electrode plates 26 of a predetermined length. While the continuous wave laser may be used to cut at predetermined longitudinal positions, another conventionally-known general means, such as a cutter, may be used. The negative electrode precursor 32 may have the length in the longitudinal direction equal to that of the negative electrode plate 26. In this case, in the cutting process, the two negative electrode plates 26 may be obtained by cutting the negative electrode precursor 32 at the lateral center without further cutting the negative electrode precursor 32 at the predetermined longitudinal positions.

FIG. 5 is a cross sectional view of an edge portion of the negative electrode plate 26 on the cut edge 28a side. FIG. 5 shows the negative electrode active material layer 28 in a hatch pattern of a sand texture, and the solidified portion of the metal foil that is used as the negative electrode core 27 and melted with the laser in a hatch pattern of diagonal lines. As shown in FIG. 5, in the negative electrode plate 26, the melted portion of the metal foil forming the negative electrode core 27 disperses such that the melted portion scatters to adhere to and solidify on the edges of the negative electrode active material layers 28 beyond the plate thickness region t of the negative electrode core 27 at the edge portion of the negative electrode plate 26 on the cut edge 28a side cut with the laser. The cross section such as the one shown in FIG. 5 can be obtained by, for example, using the continuous wave laser at the laser output of 1,200 W to 1,550 W and at the scan speed (cut speed) of the laser beam of 3,000 mm/sec to 8,000 mm/sec with respect to the negative electrode precursor 32 and by adjusting the combination of the laser output and the scan speed. Such a cross section like the one shown in FIG. 5 can also be obtained by using the continuous wave laser at the laser output of 1,200 W to 1,400 W with the scan speed of the laser beam of 5,000 mm/sec to 8,000 mm/sec, or at the laser output of 1,300 W to 1,550 W with the scan speed of the laser beam of 3,000 mm/sec to less than 5,000 mm/sec with respect to the negative electrode precursor 32.

As shown in FIG. 5, at least a longitudinal (the front-rear direction of the sheet of paper on which FIG. 5 is drawn) portion of the solidified portion of the melted portion at the edge portion of negative electrode core 27 on the cut edge 28a side extends outwards in the plate thickness direction to be joined to the cut edges 28a of the negative electrode active material layers 28. Although the cross section of the negative electrode plate 26 at a single longitudinal point is shown in FIG. 5, the cross section of the negative electrode plate 26 is likely to be similar to the one in FIG. 5 at other longitudinal points.

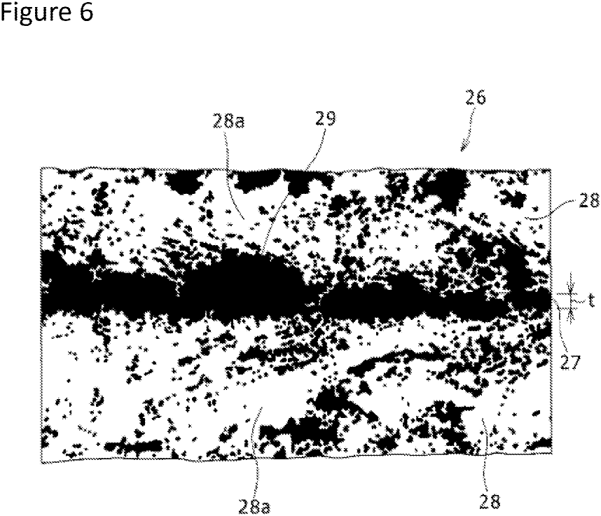

FIG. 6 depicts an SEM image of the cut edge of the negative electrode plate 26 according to an embodiment of the present disclosure. In FIG. 6, the black areas indicate the dispersed and deposited portions of the metal foil, such as a copper foil, dispersed and welded by the heat of the laser in the cutting process. Such a cut edge can be obtained by using, for example, the continuous wave laser with the laser output at 1,200 W to 1,550 W at the scan speed of the laser beam of 3,000 mm/sec to 8,000 mm/sec with respect to the negative electrode precursor 32, and adjusting the combination of the laser output and the scan speed. As shown in FIG. 6, at the cut edge of the negative electrode plate 26, the melted portion of the metal foil disperses such that the melted portion is welded to and solidified on the cut edges 28a of the lower and upper negative electrode active material layers 28 beyond the plate thickness region t of the negative electrode core 27. These solidified portions form a metal coating 29 that extends beyond the plate thickness region of the negative electrode core 27. The metal coating 29 is joined to the cut edges 28a of the two negative electrode active material layers 28 disposed on both sides in the plate thickness direction.

In a manufacturing method of the secondary battery 10, the positive electrode plate 22 is also manufactured. Similarly to the negative electrode plate 26, two semi-finished positive electrode plates or two positive electrode plates 22 can be manufactured by cutting, with laser, a positive electrode precursor at the lateral center after the compression process in which the positive electrode active material base layer is compressed. The positive electrode precursor includes a thin-plate-shaped positive electrode base core formed from a metal foil and a positive electrode active material base layer formed on each side of the positive electrode base core. Multiple positive electrode plates 22 of a predetermined length may be obtained from the two semi-finished positive electrode plates by cutting the two semi-finished positive electrode plates 22 at predetermined positions.

The method for manufacturing the secondary battery 10 includes, after manufacturing the positive electrode plate 22, the negative electrode plate 26, and the separators 30, 31, stacking the positive electrode plate 22, the negative electrode plate 26, and the separators 30, 31, and winding the stack to manufacture the electrode assembly 20. The secondary battery 10 can be manufactured by disposing the electrode assembly 20 and non-aqueous electrolytic solution in the housing 12 after the electrode assembly 20 is manufactured, and welding the sealing plate 14 around the opening edge of the housing 12. In this manner, the secondary battery 10 is manufactured using the negative electrode plate 26 manufactured by the above described method.

### Advantages

In the negative electrode plate 26 and the method for manufacturing the same, and the secondary battery 10 and the method for manufacturing the same, the solidified portion of the melted portion of the metal foil of the negative electrode core 27 at least partially extends outward in the plate thickness direction at the cut edge portion of the negative electrode core 27, and forms the metal coating 29 joined to the cut edges of the negative electrode active material layers 28. This can prevent the negative electrode active material layers 28 from peeling off at the cut edges 28a. According to embodiments of the present disclosure, the edge of the negative electrode core 27 does not need to be widened into a triangular cross section as required in the structure disclosed in Patent Literature 1.

When cutting the positive electrode precursor with the laser at the lateral center, similarly as the manufacturing method of the negative electrode plate 26, the melted portion produced by melting of the metal foil of the positive electrode core 23 may disperse to extend beyond the plate thickness region of the positive electrode core 23 at the cut edge portion of the positive electrode plate 22 and spread at the edges of the positive electrode active material layers 24. Using such a manufacturing method of the positive electrode plate 22, the positive electrode plate 22 may be configured such that the melted portion of the metal foil at the edge portion of the positive electrode plate 22 disperses beyond the plate thickness region of the positive electrode core 23 to adhere to and solidify on the edges of the positive electrode active material layers 24. In this case, because the solidified portion of the melted portion of the metal foil of the positive electrode core 23 at least partially extends outwardly in the plate thickness direction at the cut edge portion of the positive electrode core 23, and forms a metal coating joined to the cut edges of the positive electrode active material layers 24, the positive electrode active material layers 24 can be prevented from peeling off at the cut edges.

Although, in the above embodiments, the negative electrode active material layer 28 is formed on each side of the negative electrode core 27 and the positive electrode active material layer 24 is formed on each side of the positive electrode core 23, the negative electrode plate and the positive electrode plate manufactured using the methods of the present disclosure are not limited to these configurations. The negative electrode active material layer may be formed only on a single side of the negative electrode core, and the positive electrode active material layer may be formed only on a single side of the positive electrode core.

### Reference Signs List

10 secondary battery
12 housing
14 sealing plate
15 positive electrode terminal
16 negative electrode terminal
20 electrode assembly
22 positive electrode plate
22a main portion
22b positive electrode core exposed portion
23 positive electrode core
24 positive electrode active material layer
26 negative electrode plate
26a main portion
26b negative electrode core exposed portion
27 negative electrode core
28 negative electrode active material layer
28a cut edge
29 metal coating
30, 31 separators
32 negative electrode precursor
33 negative electrode base core
34 negative electrode active material base layer
35 core exposed portion
47 positive electrode current collector
48 positive electrode receiving element
50 negative electrode current collector
58 negative electrode receiving element
60 insulation tape
61 first insulating member
62 second insulating member

1. A secondary battery electrode plate comprising:
a core made from a metal foil and having a thin-plate shape;
an active material layer formed on at least one side of the core,
wherein a melted portion of the metal foil forming the core disperses at an edge portion of the secondary battery electrode plate such that the melted portion spreads beyond a plate thickness region of the core to adhere to and solidify on an edge of the active material layer.

2. A secondary battery comprising the secondary battery electrode plate according to claim 1.

3. A secondary battery electrode plate manufacturing method manufacturing the secondary battery electrode plate according to claim 1, wherein
when manufacturing the secondary battery electrode plate or a semi-finished electrode plate to be used as the secondary battery electrode plate by cutting, with laser, an electrode precursor comprising a thin-plate shaped base core made from a metal foil and an active material base layer formed on at least one side of the base core, a melted portion produced by melting the metal foil disperses at an edge portion of the secondary battery electrode plate such that the melted portion spreads beyond a plate thickness region of the core to an edge of the active material layer.

4. The secondary battery electrode plate manufacturing method according to claim 3, wherein
the electrode precursor is cut with laser at an laser output of 1,200 W to 1,400 W and a laser cut speed of the electrode precursor of 3,000 mm/sec to 8,000 mm/sec.

5. A secondary battery manufacturing method using the secondary battery electrode plate manufactured by the secondary battery electrode plate manufacturing method according to claim 3.
